(19) United States
(12) Patent Application Publication
(10) Pub. No.: US 2006/0135345 A1
(43) Pub. Date: Jun. 22, 2006

(54) Permeable refractory material for a gas purged nozzle

(75) Inventors: Priyadarshi Gautam Desai, Bridgeville, PA (US); Duane Debastiani, Moon, PA (US); Dominique Janssen, McReed Rocks, PA (US)

Correspondence Address: Vesuvius;Robert S Klemz Jr, 27 Noblestown Road, Carnegie, PA, 15106-1632, US

(73) Assignee: Vesuvius Crucible Company, Wilmington, DE (US)

(21) Appl. No.: 10/533,921

(22) PCT Filed: Oct. 14, 2003
(86) PCT No.: PCT/US03/32427

§ 371 Date: May 4, 2005

Related U.S. Application Data
(60) Provisional application No. 60/418,957, filed on Oct. 16, 2002.

(51) Int. Cl. C04B 35/52

(52) U.S. Cl. 501/99

(57) ABSTRACT

A permeable, resin-bonded composition is described, which finds utility as a porous element in a gas-injection nozzle. The permeable composition is notably useful in a canless, resin-bonded, gas-injection nozzle, characterized by an impermeable, resin-bonded composition replaces the metal can. Advantageously, the resin-bonded compositions include an oxygen getter for scrubbing oxygen before the oxygen can reach the molten steel. A method of manufacturing the nozzle is described and includes copressing a standard, resin-bonded composition around the permeable, resin-bonded composition. The pressed piece may be cured at temperatures below about 800° C.

### FIELD OF THE INVENTION

This invention relates to a refractory nozzle for use in the casting of molten steel, and particularly to a nozzle that uses inert gas for reducing unwanted accumulation of alumina deposits at the steel/nozzle interface.

### BACKGROUND OF THE INVENTION

Refractory articles for controlling a flow of molten metal, such as steel, are known in the prior art. Such articles include nozzles, slide gate plates, stopper rods and shrouds, and are often used in combination to modulate a flow of liquid steel during the casting of molten metal. In the 1970's, aluminum-killed steels became one of the most common products of the steel making industry due to its desirable metallurgical properties.

Unfortunately, during casting, metal oxides, such as alumina, deposit and accumulate on surfaces where molten steel contacts the refractory articles. Contacting surfaces include, for example, the bore and top surface of a nozzle. Oxide deposits in the bore can ultimately cause the complete blockage of the nozzle. Alternatively, deposits at the top surface can prevent shut-off of the molten steel stream because a stopper rod can no longer sealingly engage the top surface of the nozzle.

Research has shown that alumina deposits form when oxygen reacts with constituents in the nozzle and the molten steel. Shielding the molten steel from oxygen effectively reduces unwanted deposits. Shielding may be accomplished by injecting an overpressure of inert gas, such as argon, into the refractories surrounding [symbol] eel. Injection reduces the partial pressures of oxygen [symbol] clogging.

Nozzle assemblies that permit inert gas injection frequently include a refractory article and a metal can. The refractory article is usually secured in the metal can with a refractory mortar. The article may include a gas delivery system comprising a plurality of holes opening onto a contacting surface, or a porous, gas-conducting refractory element adjacent to a contacting surface. The latter is typically surrounded by or imbedded in a second refractory component. The nozzle assembly may also include a gas delivery system comprising channels, grooves or devices, within or outside the nozzle that direct inert gas to the holes or porous elements. Examples of such nozzles include U.S. Pat. Nos. 4,360,190; 5,100,035, 5,137,189, and 5,723,055.

The metal can acts as an impervious barrier, thereby reduces the likelihood that oxygen will diffuse into the refractory article and injected inert gas will escape from the article. The metal can, therefore, reduces the amount of gas needed to maintain a low partial pressure of oxygen. Unfortunately, gas can still leak from the nozzle assembly, and oxygen can still find its way into the nozzle assembly. The mortar interface between the metal can and the refractory nozzle is highly permeable to gas diffusion. Differences in thermal expansion often create a gap between the metal can and the refractory. Also, the metal can substantially degrade during casting. High temperatures combined with mechanical stress can induce significant creep and plastic behavior in the metal can. The metal can perforate, thereby becoming incapable of containing the inert gas within the refractory article or preventing oxygen from aspirating into the molten metal. [symbol] es diffusion of oxygen around or through the metal can, oxygen may also be present as a contaminate in the inert gas. Impure inert gas and leaks in the gas feed lines can also allow significant quantities of oxygen to pass to the porous element. Oxygen readily passes through prior art porous elements and can react with the molten steel to form deposits. Prior art elements typically consist of carbon-bonded materials or oxide-bonded material, and do not remove oxygen from the incoming stream of gas.

A need exists for a refractory nozzle that better shields the molten steel from oxygen. Prior art nozzles still permit the diffusion of oxygen through the article and into the molten steel. Metal cans do not completely prevent oxygen diffusion to the molten steel. Oxygen can still penetrate along the interface between the article and the metal can and is able to pass through the metal can at casting temperatures. Furthermore, “canning” significantly adds to the expense of the product. Preferably, the nozzle would include a gas impermeable barrier with a thermal expansion coefficient similar to the porous element. Advantageously, shielding would include both mechanical and chemical means. More preferably, the porous element would scavenge or scrub whatever oxygen was present in the inert gas or was able to penetrate through the barrier.

### SUMMARY OF THE INVENTION

The present invention describes a porous, resin-bonded composition and a refractory nozzle comprising the composition. The porous resin-bonded composition may be used in the casting of molten steel in order to reduce the accumulation of deposits on surfaces exposed to a stream of molten steel. Surfaces include the bore or top sealing surface of the resin-bonded nozzle. [symbol] broad aspect, the permeable material includes a porous, [symbol] composition that is permeable to inert gas. Permeability may be controlled, for example, by adjusting particle size, forming pressure, level of fugitive additives, or drilling holes in the material. The composition includes refractory aggregate, binder and oxygen getters. The latter includes reactive metals and certain boron compounds. Refractory aggregate includes any suitable refractory material, such as alumina, magnesia, silica, zirconia, calcia, and mixtures and compounds thereof. The cured composition retains a permeability of at least 50 cD.

One embodiment includes a permeable material made from a particulate refractory mixture comprising at least about 60 wt. % aggregate having a particle size of +80 mesh or higher, less than 20 wt. % aggregate having a particle size of +325 to −80 mesh, and less than 20 wt. % aggregate having a particle size less than −325 mesh.

The permeable material may be included as a porous element in an article for protecting molten steel from oxygen. The porous element is positioned to permit the introduction of inert gas into or around the molten steel stream. Advantageously, the porous element comprises oxygen getters that scrub oxygen from the inert gas so that residual oxygen cannot induce the accumulation of deposits.

An impermeable material substantially surrounds the porous element, thereby containing the inert gas within the article and directing the inert gas into and through the porous element toward the molten steel. Conveniently, one can control the porosity of the permeable composition and the diffusion of inert gas into the molten steel. Alternatively or in conjunction with porosity, a gas delivery system, such as channels, grooves or devices, may facilitate the delivery and diffusion of inert gas through the permeable material.

In one embodiment, the permeable material is co-pressed with [symbol] gas impermeable composition to form a refractory article. Use of the impermeable composition permits the elimination of a metal can, thereby saving on manufacturing costs and eliminating the permeable interface between the can and the refractory. Unlike a metal can, the impermeable composition has a thermal expansion coefficient similar to the permeable composition, and does not deteriorate at casting temperatures.

The method of the present invention includes copressing an impermeable composition around a permeable composition. Heating the compositions above about 150° C., and preferably above about 200° C., for a sufficient time to create a resin bond and, unlike carbon- and oxide-bonded compositions, avoiding premature reaction of the oxygen getters.

### BREIF DESCRIPTION OF THE DRAWINGS

FIG. 1 shows a cross-section of a refractory nozzle of the prior art.

FIG. 2 shows a cross-section of a refractory nozzle of the present invention.

### DETAILED DESCRIPTION OF THE INVENTION

The present invention describes a permeable, resin-bonded composition, and a canless, resin-bonded refractory nozzle comprising the composition that may be used to inject gas into a flow of molten metal. Resin-bonded means pressed, particulate compositions that cure at temperatures less than 800° C., and usually at temperatures less than 500° C. In contrast, carbon-bonded and oxide-bonded materials require curing at significantly higher temperatures. Carbon-bonded materials are fired in reducing atmospheres at temperatures greater than 800° C. and frequently greater than 1000° C. Oxide-bonded materials are fired at even higher temperatures. [symbol] ntageously, low curing temperatures permit the addition [symbol] various beneficial compounds. For example, reactive metals, such as aluminum and magnesium, will oxidize or form carbides at elevated temperatures, but will remain in their elemental state during resin-bonded curing. Unfortunately, resin-bonded compositions are typically impermeable to gases and are not amendable to use as a porous element for a gas-injection nozzle. Permeability is measured by according to ASTM Standard C-577, and involves forming a two (2) inch cube of the material to be tested, applying a backpressure of 3-6 psi, and measuring the flow rate through the cube.

After exposure to a temperature of 1000° C., which corresponds to preheating of a refractory article in the continuous casting of steel, resin-bonded compositions will often have a permeability of less than about 15 cD. More commonly, permeability is less than 5 cD. A porous element should have a permeability of at least about 50 cD.

The present resin-bonded, permeable composition comprises refractory aggregate, binder and oxygen getters. Refractory aggregate includes any suitable refractory material, such as alumina, zirconia, calcia, and mixtures and compounds thereof. Preferably, compounds that produce volatile oxides at elevated temperatures, such as silica and magnesia, should be limited.

The permeable composition comprises a resin-bonded composition having a permeability of at least about 50 cD, a porosity of at least about 15%, and a median pore size of at least about 5 microns. Preferably, permeability is above 100 cD; porosity is greater than 20%; and median pore size is greater than 10 microns. In contrast, a standard resin-bonded composition comprises a permeability of less than porosity of 9-14%, and a median pore size of 2-4 microns, [symbol] standard, tar-impregnated carbon-bonded composition comprises a permeability of less than 10 cD, a porosity of less than 20%, and a median pore size of about 1 micron.

Permeability may be altered by various methods, including pressing, particle size distribution, fugitive additives, drilling, and chemical compositions, either individually or in combination. Theoretically, reducing the pressure of pressing to only 1000-3000 would increase permeability, but physical properties, particularly erosion- and corrosion-resistance can significantly decrease. Fugitive additives include materials that volatilize, melt or decompose below casting temperatures, and include waxes and other organic materials known to one skilled in the art. Fugitive additives increase permeability upon heating, where heating means either curing the material or subsequent heating of the cured material during or just prior to use. Lasers may also be used to drill small holes in the material, thereby creating gas channels in the material. Various chemicals can induce gas formation, thereby generating pores in the material. Other chemicals, such as fluxes, can decrease porosity.

Preferably, permeability is controlled by the particle size distribution of the refractory aggregate. The distribution comprises a majority of a large particle size aggregate and a small particle size aggregate that does not completely fill interstices between the large aggregate. The smaller particle size aggregate should be at least about one-third, and preferably one-half, the size of interstices of the large aggregate. A third aggregate having an even smaller particle size may be added to fine-tune porosity, facilitate processing, or improve strength of the cured article. In one embodiment, a suitable particle size distribution includes at least about [symbol] wt. % aggregate having a particle size of +80 mesh or higher, less than 20 wt. % aggregate having a particle size of +325 to −80 mesh, and less than 20 wt. % aggregate having a particle size less than −325 mesh.

The curable resin binder should be present in an amount to achieve adequate green strength after pressing and curing. Pressing will usually be at least about 3000 psi to achieve good erosion- and corrosion-resistance. Curing for a resin-bonded composition typically occurs at or below around 300° C. For additional strength, the composition may be heat treated at a temperature below about 800° C. and most preferably below about 500° C. One must be exercise caution when heat-treating because permeability may change at elevated temperatures. The amount of binder will vary depending on, for example, the type of binder used and the desired green strength. A sufficient amount of binder will typically be from 1-10 wt. %. Typically, the binder is organic and usually the binder is a carbon-based resin, such as, phenolic resins, carbonaceous binders derived from pitch or resin, starch, or ligno-sulfonates.

The gas-impermeable composition also comprises an oxygen getter. An oxygen getter reacts with oxygen that diffuses into or forms within the gas-impermeable composition, thereby making the oxygen unavailable to the molten steel. Common oxygen getters include, for example, boron compounds, carbides, nitrides, and reactive metal powders such as aluminum, magnesium, silicon and mixtures and alloys thereof. Boron compounds are particularly effective oxygen getters, and include elemental boron, boron nitride, boron carbide, and mixtures thereof. Because boron compounds can act as a flux, thereby reducing porosity, their use should be carefully limited. [symbol] needed quantity of oxygen getter depends on the particular [symbol] the refractory article will be placed. A minimum of 0.25 wt. % is believed necessary to show demonstrable improvement in oxidation-resistance. Alternatively, more than 15 wt. % is costly, typically unnecessary, and may even be hazardous such as when using reactive metal powders. Additionally, oxygen getters may decrease thermal shock-resistance and erosion-resistance of the article.

A preferred oxygen getter comprises a reactive metal, including aluminum, magnesium, silicon, titanium, and mixtures and alloys thereof. Conveniently, reactive metals are added as powders, flakes and the like. The reactive metal should be present in sufficient quantity so that, during casting of molten steel, the reactive metal scavenges any oxygen that may diffuse into or emanate from the refractory article. Various factors affect the amount of reactive metal that will be sufficient to scavenge oxygen. For example, the inclusion of oxygen-releasing compounds, such as silica, require higher levels of reactive metal in order to scavenge the released oxygen. Limitations on the amount of reactive metal include cost and hazardousness. Reactive metals are generally more expensive than refractory aggregates and, especially as powders, reactive metals can be explosive during processing. A typical amount of reactive metal is from 5-12 wt. %.

Graphite may be added to the permeable, resin-bonded composition in order to improve thermal-shock resistance. Preferably, the level of graphite will not exceed about 10 wt. %. Graphite has been correlated with alumina deposition, so the amount of graphite should be kept as low as needed.

The nozzle of the present invention includes a porous, resin-bonded element, surrounded by an impermeable element, such as a metal can or impermeable [symbol] nposition. Nozzle means any refractory article used to [symbol] molten metal, including ladle and tundish nozzles such as well nozzles, subentry nozzles, subentry shrouds, and collector nozzles.

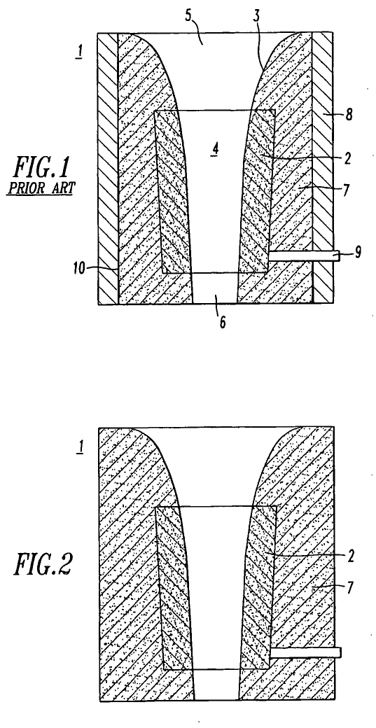

FIG. 1 shows a nozzle 1 of the prior art. A porous element 2 forms at least a portion of the inner surface 3 of the nozzle 1, and is adapted to deliver inert gas to the bore 4 of the nozzle 1. The bore 4 is adapted to transfer the steel from the nozzle inlet 5 to the nozzle outlet 6. The porous element 2 is at least partially surrounded by a nozzle body 7 comprising a second refractory material. The refractory elements are mortared at least in part within a metal can 8. During casting, a conduit 9 delivers inert gas to the nozzle 1. The inert gas may also pass through a combination of channels, grooves or devices within or surrounding the nozzle 1.

The porous element 2 typically comprises an oxide-bonded or phosphate-bonded material having a relatively open pore structure and a permeability of at least about 50 cD, and more frequently greater than 150 cD. A typical porous element includes an oxide-bonded magnesia, an alumina-chrome, or high alumina composition. The second refractory material is usually a carbon-bonded or castable refractory. Castable refractory includes those particulate materials to which water is added, and which subsequently harden. Examples include refractories comprising a hydratable compound, such as calcia, that react with water to form a hard product. The metal can 8 is intended to be a gas impermeable barrier, which prevents gas leakage or oxygen ingress.

Whether carbon-bonded or castable, the second material, while not porous enough to comprise the porous element, is porous enough to permit leakage of inert gas and ingress of oxygen. Numerous other opportunities exist for oxygen to contact [symbol] el. The mortar joint 10 between the nozzle body [symbol] is often porous and readily permits oxygen diffusion. Differences in thermal expansion between the nozzle body 7, the metal can 8, or the conduit may also produce cracking. Oxygen can flow along these cracks to the molten steel. Oxygen may also contaminate the inert gas feed, whether as a trace impurity in the gas itself or by leakage in the delivery system.

As shown in FIG. 2, one embodiment of the present invention is a nozzle 1 including a porous element 2 comprising the porous, resin-bonded composition. The porous element 2 is surrounded at least in part by a nozzle body 7 comprising a substantially impermeable material. The impermeable material may comprise a metal can but, as shown in FIG. 2, the impermeable material may comprise a second resin-bonded composition. The second resin-bonded composition is substantially impermeable to gas, and substitutes for the metal can of the prior art. Advantageously, a mortar joint is unnecessary, and the impermeable refractory does not deteriorate at casting temperatures. In an alternative embodiment, the nozzle body may substantially comprise a permeable material and even a porous, resin-bonded composition provided an impermeable material substantially forms the outer surface of the nozzle body. Conveniently, the impermeable material comprises a metal can and the remainder of the nozzle consists essentially of a refractory ceramic material. The refractory ceramic material may comprise a plurality of ceramic components, or may simply consist of the porous element. Advantageously, the latter embodiment is easily manufactured using a single pressing step, a single curing step, and a single canning step.

The impermeable material of the nozzle should have a permeability of less [symbol] cD, and preferably less than 5 cD. One skilled in the art is aware of various impermeable ceramic or metallic materials, and several methods to produce an impermeable ceramic material using a variety of chemical and mechanical means. For examples, fluxes, glazes, particle size distribution, bonding system, composition of the refractory, and processing conditions can individually and in combination affect permeability. Fluxes introduce low temperature phases and facilitate vitrification. Glazes produce an impervious coating on the surface of the refractory. Particle size distribution in a refractory aggregate can substantially affect porosity, and ultimately permeability, in a finished product. Processing conditions, such as firing temperature and pressing, have profound effects on permeability. Chemical compositions of the refractory and bonding system also substantially affect permeability.

The impermeable composition preferably comprises a resin-bonded composition. The impermeable composition includes at least one refractory aggregate, a curable resin binder and a reactive metal. Refractory aggregate includes any refractory material suitable for steel casting, including but not limited to alumina, magnesia, calcia, zirconia, silica, compounds and mixtures thereof. A typical impermeable composition comprises 50-90 wt. % refractory aggregate, 1-10 wt. % binder, and 0.5-15 wt. % reactive metal. More preferably, the impermeable composition comprises 65-80 wt. % fused alumina, 2-30 wt. % calcined alumina, 1-10 wt % binder, 0.5-10 wt. % aluminum metal, up to 15 wt. % zirconia, and less than 3 wt. % silica. Graphite may be added for processing or thermal-shock resistance, and is conveniently added at levels of 0.5-10 wt. %.

Gas delivery systems can increase gas transport in the refractory nozzle. Such systems comprise channels, grooves or devices within or on a surface of the refractory article. The device can be perforated to permit uniform distribution of gas along its length. Channels are frequently produced by burning out wax or other low melting point material that had been pressed or cast into the refractory article.

The method of the invention includes forming the permeable composition such as, for example, by pressing or extruding, and curing the permeable composition to form the porous element. Curing occurs at temperatures below about 800° C., preferably below about 500° C., and most preferably at or below 300° C. Low cure temperature preserves the oxygen getters in the resin-bonded compositions. The impermeable composition is then placed substantially all around the porous element to form the finished refractory nozzle. Multiple firing or canning steps are avoided. In one embodiment, the permeable composition is copressed with the impermeable composition to form a pressed piece, which is cured to form the finished nozzle. Copressing will most often occur at pressures over 3000 psi to ensure adequate mechanical strength, including erosion- and corrosion-resistance. In this embodiment and unlike prior art, a metal can and high temperature firing are unnecessary.

### EXAMPLE 1

As shown in Table 1, the permeability of a permeable, resin-bonded composition (A) was compared with permeabilities of three, prior art compositions (B-D). Composition A comprised a permeable resin-bonded material based on an alumina aggregate. Composition B was a standard, non-permeable resin-bonded material. Composition C was a standard, permeable oxide-bonded magnesia Composition D was a standard, fired carbon-bonded refractory. The resin-bonded compositions were cured at 200° C. The oxide-bonded material was fired at greater 13 [symbol] ro more than four hours. The carbon-bonded composition [symbol] greater than 800° C. for more than four hours in a reducing atmosphere. Permeability was performed according to ASTM Standard C-577. The permeability of the permeable resin-bonded material greatly surpassed the standard resin-bonded and carbon-bonded materials, and compared favorably with the oxide-bonded magnesia.

| | A | B | C | D |
|---|---|---|---|---|
| | Permeable | Standard | Oxide- | Carbon- |
| | Resin-Bond | Resin-Bond | Bond | Bond |
| Permeability in | 65-250 | 1-20 | 65-250 | 1-15 |
| cD, after 1000° C. | | | | |

### EXAMPLE 2

Table 2 shows the oxygen scrubbing capacity of various refractory compositions. Scrubbing capacity is measured by heating samples to 1200° C. in argon, exposing the samples to air at 1200° C., and weighing the samples. An increase in weight indicates the absorption of oxygen by the sample, which typically means the reaction of oxygen with a constituent in the sample to produce an oxide. Samples A-C comprise (A) a permeable resin-bonded material of the present invention, (B) an impermeable resin-bonded material, and (C) a fired, oxide-bonded magnesia composition. Sample A, the permeable resin-bonded material, absorbs substantially more oxygen at all times and continues to absorb oxygen faster than Sample B, even after three hours. Sample C, the fired refractory without oxygen getters, absorbed no oxygen.

| | Weight Gain, % | | |
|---|---|---|---|
| Time, hrs | A | B | C |
| 1 | 1.9 | 0.9 | 0 |
| 2 | 2.4 | 1.1 | 0 |
| 3 | 2.7 | 1.2 | 0 |

Obviously, numerous modifications and variations of the present invention are possible. It is, therefore, to be understood that within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of this patent, which is limited only by the claims appended hereto.

What is claimed is:

1-17. (canceled)

18. A permeable material having a permeability of at least about 50 cD characterized by the material being resin-bonded and made from a composition comprising:
a) a refractory aggregate;
b) 0.5-15 wt. % of at least one oxygen getter; and
c) a sufficient amount of binder.

19. The permeable material of claim 18, characterized by the refractory aggregate comprising at least 80 wt. % of the composition, and the refractory aggregate including:
a) at least about 60 wt. % aggregate having a particle size of +80 mesh or higher;
b) less than 20 wt. % aggregate having a particle size of −80 to +325 mesh; and
c) less than 20 wt. % aggregate having a particle size less than −325 mesh.

20. The permeable material of claim 19, characterized by the refractory aggregate comprising at least one oxide selected from the group consisting of alumina, magnesia, silica, zirconia, calcia, and mixtures and compounds thereof.

21. The permeable material of claim 18, characterized by the oxygen getter comprising at least one compound selected from the group consisting of boron compounds, carbides, nitrides, and reactive metals.

22. The permeable material of claim 21, characterized by the reactive metal being selected from the group consisting of aluminum, magnesium, silicon, titanium, and mixtures and alloys thereof.

23. The permeable material of claim 18, characterized by the binder being selected from the group consisting of phenolic resins, carbonaceous binders, starch, and ligno-sulfonates.

24. The permeable material of claim 18, characterized by the composition comprising a fugitive additive capable of increasing permeability during heating of the permeable material.

25. The permeable material of claim 24, characterized by the fugitive additive comprising an organic compound.

26. The permeable material of claim 18, characterized by the permeable material lining at least an inner surface of a refractory nozzle for use in the casting of molten metal, wherein the nozzle includes an inlet, an outlet, an outer surface, the inner surface defining a bore fluidly connecting the inlet and the outlet, and a top surface surrounding the inlet, the nozzle adapted to receive a flow of inert gas and comprising an impermeable material surrounding at least a portion of the permeable composition and substantially preventing diffusion of gases through the outer surface.

27. The permeable material of claim 26, characterized by the impermeable material being selected from the group consisting of metal and an impermeable refractory composition.

28. The permeable material of any one of claim 26, characterized by the impermeable refractory composition being made from a composition comprising [symbol] wt. % refractory aggregate, 1-10 wt. % binder, and 0.5-15 wt. % reactive metal.

29. The permeable material of claim 26, characterized by the impermeable composition comprising 65-80 wt. % fused alumina, 2-30 wt. % calcined alumina, 1-10 wt. % binder, 0.5-10 wt. % aluminum metal, up to 15 wt. % zirconia, and less than 3 wt. % silica.

30. The permeable material of claim 26, characterized by the nozzle including an inert gas delivery system.

31. The permeable material of claim 30, characterized by the gas delivery system being selected from the group consisting of channels, grooves and devices.

32. The permeable material of claim 26, characterized by the nozzle being made by:
a) placing a first composition adapted to be the permeable material around a mandrel in a mold;
b) placing a second composition adapted to be the impermeable composition at least partially around the first composition;
c) pressing the first and second compositions together at a pressure of at least about 3000 psi to form a green piece;
d) curing the green piece at a temperature less than 800° C. to form the nozzle.

33. The permeable material of claim 32, characterized by the first composition comprising:
a) at least 80 wt. % refractory aggregate including a least about 60 wt. % aggregate having a particle size of +80 mesh or higher, less than 20 wt. % aggregate having a particle size of −80 and +325 mesh, and less than 20 wt. % aggregate having a particle size less than −325 mesh;
b) 0.5-15 wt. % of at least one oxygen getter; and
c) a sufficient amount of binder.

34. The permeable material of claim 33, characterized by the second composition comprising:
a) 50-90 wt. % refractory aggregate;
b) 1-10 wt. % binder; and
c) 0.5-15 wt. % reactive metal
